(19) United States
(12) Patent Application Publication
(10) Pub. No.: US 2025/0095300 A1
(43) Pub. Date: Mar. 20, 2025

(54) METHODS AND DEVICES FOR INTERACTIVE RENDERING OF A TIME-EVOLVING EXTENDED REALITY SCENE

(71) Applicants: InterDigital CE Patent Holdings, SAS, Paris (FR); INTERDIGITAL VC HOLDINGS FRANCE, SAS, Cesson Sevigne (FR)

(72) Inventors: Patrice Hirtzlin, Betton (FR); Pierrick Jouet, Rennes (FR); Vincent Alleaume, Pace (FR); Sylvain Lelievre, Montgermont (FR); Loic Fontaine, noyal sur vilaine (FR)

(21) Appl. No.: 18/727,962

(22) PCT Filed: Jan. 9, 2023
(86) PCT No.: PCT/EP2023/050299

§ 371 Date: Jul. 10, 2024

(30) Foreign Application Priority Data
Jan. 12, 2022 (EP) 22305024.6

(51) Int. Cl. G06T 19/00; G06F 3/01

(52) U.S. Cl. CPC G06T 19/00; G06F 3/011

(57) ABSTRACT

An extended reality scene description is provided comprising relationships between real and virtual objects and interactive triggering and processing of the extended reality scene; An extended reality system can read the scene description and run a corresponding extended reality application. The scene description comprises a scene graph structuring descriptions of the real and virtual objects which may be linked to media content items. It also comprises of behavior metadata items describing how a user can interact with the scene objects at runtime. Method and devices are disclosed to manage the behaviors comprising triggers and actions and to manage the on-going behaviors when a second scene description is received.

### 1. TECHNICAL FIELD

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Although such scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description comprising metadata describing how a user can interact with the scene objects at runtime and how these interactions may be updated during runtime of the XR application.

### 3. BRIEF DESCRIPTION OF DRAWINGS

The present disclosure will be better understood, and other specific features and advantages will emerge upon reading the following description, the description making reference to the annexed drawings wherein:

FIG. 1 shows an example scene graph of an extended reality scene description according to the present principles;

FIG. 2A shows a syntax to represent the triggers of the illustrative example according to the present principles;

FIG. 2B shows a syntax to represent the actions of the illustrative example according to the present principles;

FIG. 2C shows a syntax to represent the behaviors of the illustrative example according to the present principles;

FIG. 2D shows an example syntax of complementary information according to the present principles;

FIG. 3 shows an example architecture of an XR processing engine which may be configured to implement a method described in relation with FIGS. 5 and 6 according to the present principles;

FIG. 4 shows an example of an embodiment of the syntax of a data stream encoding an extended reality scene description according to the present principles;

FIG. 5 illustrates a method for rendering an extended reality scene according to a first embodiment of the present principles;

FIG. 6 illustrates a method for rendering an extended reality scene according to a second embodiment of the present principles.

### 4. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

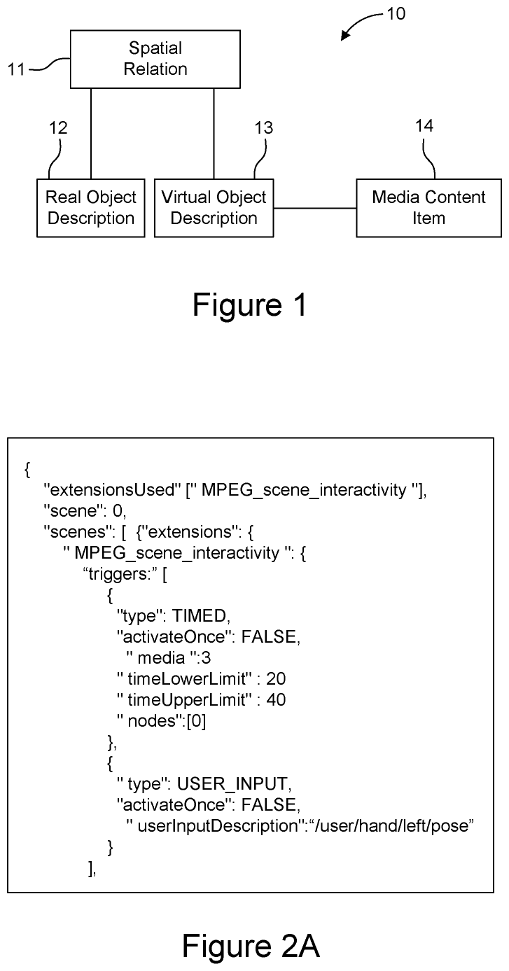

FIG. 1 shows an scene example graph 10 of an extended reality scene description. In this example, the scene graph comprises a description of a real object 12, for example ‘plane horizontal surface’ (that can be a table or the floor or a plate) and a description of a virtual object 13, for example an animation of a walking character. Virtual object 13 is associated with a media content item 14 that is the encoding of data required to render and display the walking character (for example as a textured animated 3D mesh). Scene graph 10 also comprise a node 11 that is a description of the spatial relation between the real object described in node 12 and the virtual object described in node 13. In this example, node 11 describes a spatial relation to make the character walk on the plane surface. When an XR application including the scene graph 10 is started, media content item 14 is loaded, rendered and buffered to be displayed when triggered. When a plane surface is detected in the real environment by sensors (a camera in the example of FIG. 1), the application displays the buffered media content item as described in node 11. The timing is managed by the application according to features detected in the real environment and to the timing of the animation. A node of a scene graph may also lack description and only play a role of a parent for child nodes.

XR applications are various and may apply to different context and real or virtual environments. For example, in an industrial XR application, a virtual 3D content item (e.g. piece A of an engine) is displayed when a reference object (piece B of an engine) is detected in the real environment by a camera rigged on a head mounted display device. The 3D content item is positioned in the real-world with a position and a scale defined relative to the detected reference object.

For example, in an XR application for interior design, a 3D model of a piece of furniture can be displayed when a given image from the catalog is detected in the input camera view. The 3D content is positioned in the real-world with a position and scale which is defined relative to the detected reference image. In another application, an audio file might start playing when the user enters an area which is close to a church (being real or virtually rendered in the extended real environment). In another example, an ad jingle file may be played when the user sees a can of a given soda in the real environment. In an outdoor gaming application, virtual characters may appear, depending on the semantics of the scenery which is observed by the user. For example, birds characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn the user of the potential danger. Furthermore, the sound may be spatialized in order to make it appear to arrive from the direction where the car was detected.

An XR application may also augment a video content rather than a real environment. The video is displayed on a rendering device and virtual objects described in the node tree are overlaid when timed events are detected in the video. In such a context, the node tree comprises only descriptions of virtual objects.

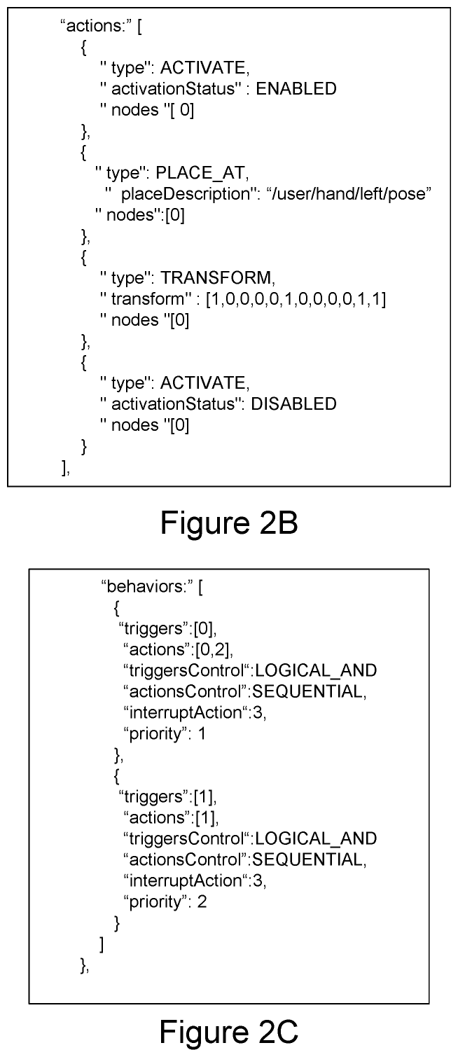

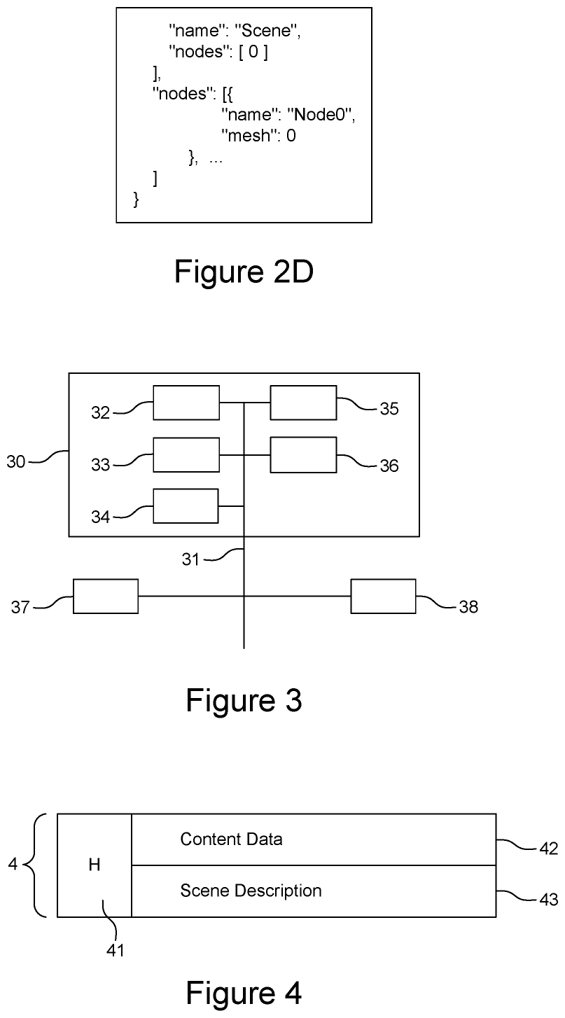

FIGS. 2A to 2D show a non-limitative example of an extended reality scene description according to the present principles.

According to the present principles, in addition to a node tree as described in relation to FIG. 1, behavior metadata items (herein called ‘behaviors’) are added to the scene description. The behaviors are related to pre-defined virtual objects with which runtime interactivity is allowed for user-specific XR experiences. The behaviors are also time-evolving and are updated through a scene description update mechanism. According to the present principles, a behavior is a metadata item that can comprise:
One or more triggers defining the one or more conditions to be met for its activation,
a triggers control parameter defining the logical operations between the triggers,
actions to process when the triggers are activated according to the triggers control parameter,
an action control parameter defining the order of execution of the actions.
a priority number enabling the selection of the behavior of highest priority in case of concurrence of at least two behaviors on the same virtual object at the same time,
an optional interrupt action to specify how to terminate the actions of this behavior that are longer appliable in a scene description update.

When a second scene description is received, some of the behaviors of the first scene description may be “on-going”, that is they have been triggered, and their actions are running. The second scene description may be provided as update metadata, that is metadata describing the differences between the first scene description and the second description. The second scene description comprises a node tree describing objects that may be common with or different from objects of the first scene descriptions. Objects of the node tree of the first scene description may be no longer present in the second description. If the objects related to the running actions of the on-going behaviors are missing in the second scene description, then, these on-going behaviors are no longer appliable. The same way, if an on-going behavior is not defined in the second description, the on-going behavior is no longer appliable. The interrupt action field describes how correctly to interrupt the running actions on the on-going behavior.

The format of the node tree is not described herein. For example, the MPEG-I Scene Description framework using the Khronos glTF extension mechanism may be used for the node tree. In this example, an interactivity extension according to the present principles may apply at the glTF scene level and is called MPEG_scene_interactivity. The corresponding semantic is provided in the following table:

| Name | Type | Usage | Description |
|---|---|---|---|
| triggers | Array | M | Contains the definition of the triggers used in that scene |
| actions | Array | M | Contains the definition of the actions used in that scene |
| behaviors | Array | M | Contains the definition of the behaviors used in that scene. A |
| | | | behavior is composed of a pair of (triggers, actions), control |
| | | | parameters of triggers and actions, a priority weight and an |
| | | | optional interrupt action |

An ‘M’ in ‘Usage’ column means that this field is mandatory in an XR scene description format according to the present principles and an ‘O’ in the ‘Usage’ column means the field is optional.

In the example presented in FIGS. 2A to 2D, a virtual 3D object is continuously displayed and transformed during a media sequence. Once the user left hand is detected, the virtual 3D object is placed on the user left hand and continuously follows it.

Two behaviors are defined to support this example interactivity scenario:
A first behavior having the following parameters:
   a single trigger related to a time sequence of the media between 20 s and 40 s with a continuous activation, and
   two sequential actions to enable and transform the virtual 3D object (node 0).
A second behavior having the following parameters:
   a single trigger related to the user left-hand detection with a continuous activation, and
   a single action to place the virtual object (node 0) on the user left hand.

Items of the array of field ‘triggers’ are defined according to the following table:

| Name | Type | Usage | Description |
|---|---|---|---|
| type | enumeration | M | Defines the type of the trigger by taking one of |
| | | | the following values: |
| | | | VISIBILITY = 0, |
| | | | PROXIMITY = 1, |
| | | | USER_INPUT = 2, |
| | | | TIMED = 3, |
| | | | COLLIDER = 4 |
| activateOnce | Boolean | M | If FALSE: the trigger is activated each time its |
| | | | conditions are met. |
| | | | If TRUE: the trigger is activated once when its |
| | | | conditions are met. |
| If (type=VISIBILITY) { | | | |
| cameraNode | number | M | Index of the node containing a camera in the |
| | | | nodes tree for which the visibilities are |
| | | | determined |
| nodes | array | M | Indices of the nodes in the node tree to be |
| | | | considered. All the nodes shall be visible by the |
| | | | camera to activate the trigger. |
| } | | | |
| If (type = PROXIMITY) | | | |
| { | | | |
| distanceLowerLimit | number | M | Threshold min in meters for the node proximity |
| | | | calculation |
| distanceUpperLimit | number | O | Threshold max in meters for the node |
| | | | proximity calculation |
| nodes | array | | Indices of the nodes in the nodes array to be |
| | | | considered. All the nodes shall have a distance |
| | | | from the user camera above the |
| | | | distanceLowerLimit and below the |
| | | | distanceUpperLimit to activate the trigger |
| } | | | |
| If(type = USER_INPUT) | | | |
| { | | | |
| userInputDescription | String/Model | M | Describe the user body part and gesture related |
| | | | to the input. For instance as specified in |
| | | | OpenXR for the interaction profile path (e.g. |
| | | | “/user/hand/left/grip”). Other representations |
| | | | can be used as an array of vertices (geometric |
| | | | model) and a binary mask (body part mask) |
| | | | used to specify where haptic effects are |
| | | | applied. |
| nodes | array | O | Indices of the nodes in the nodes tree to be |
| | | | considered for this user input. |
| } | | | |
| If (type == TIMED) { | | | |
| media | number | M | Index of the media in a media array used to |
| | | | retrieve the incremented media timeline. The |
| | | | incremented time shall be higher than the |
| | | | timeLowerLimit and below the |
| | | | timeUpperLimit to activate the trigger. |
| timeLowerLimit | number | M | Threshold min in seconds. |
| timeUpperLimit | number | O | Threshold max in seconds. |
| } | | | |
| If (type == COLLIDER) | | | |
| { | | | |
| nodes | array | M | Indices of the nodes in the nodes tree to be |
| | | | considered for collision determination. Any |
| | | | detection of collision may activate the trigger. |
| } | | | |

For every field in the table, a default value may be determined.

FIG. 2A shows a syntax compliant with the present principles to represent the triggers of the illustrative example described above. FIG. 2A shows a header indicating that interactivity metadata according to the present principles belong to the scene description. The two triggers needed for the two behaviors of the illustrative example are described. The triggers may have been listed within the behavior fields. Listing them in a separate array allows to use a same trigger for several behaviors.

Items of the array of field ‘actions’ (illustrated in FIG. 2B) are defined according to the following table:

| Name | Type | Usage | Description |
|---|---|---|---|
| type | enumeration | M | Defines the type of the action by taking one of |
| | | | the following values: |
| | | | ACTIVATE = 0, |
| | | | TRANSFORM = 1, |
| | | | ANIMATE = 2, |
| | | | CONTROL_MEDIA = 3, |
| | | | PLACE_AT = 4, |
| | | | MANIPULATE = 5, |
| | | | SET_MATERIAL = 6 |
| delay | number | O | Duration of delay in seconds before executing |
| | | | the action. |
| If (type = ACTIVATE) { | | | |
| activationStatus | enum | M | ENABLED=0: the node shall be considered |
| | | | by the application, |
| | | | DISABLED =1: the node shall not be |
| | | | considered by the application. |
| nodes | array | M | Indices of the nodes in the node tree to set the |
| | | | activation status. |
| } | | | |
| If (type = | | | |
| TRANSFORM) { | | | |
| transform | | M | 4x4 transformation matrix to apply to the |
| | | | nodes. |
| nodes | array | M | Indices of the nodes in the node tree to be |
| | | | transformed. |
| } | | | |
| If (type = ANIMATE) { | | | |
| animation | number | M | index of the animation in an animation array |
| | | | to be considered. |
| animationControl | enum | M | PLAY = 0, |
| | | | PAUSE = 1, |
| | | | RESUME = 2, |
| | | | STOP = 3 |
| } | | | |
| If (type= | | | |
| CONTROL_MEDIA) { | | | |
| media | number | M | Index of the media in a media array to be |
| | | | considered. |
| mediaControl | enum | M | PLAY = 0, |
| | | | PAUSE = 1, |
| | | | RESUME = 2, |
| | | | STOP = 3 |
| } | | | |
| If (type = PLACE_AT) { | | | |
| placeDescription | string | M | Describe the place position. E.g. |
| | | | “/user/hand/left/pose” |
| nodes | array | M | Indices of the nodes in the node tree to be |
| | | | placed. |
| } | | | |
| If (type = | | | |
| MANIPULATE) { | | | |
| action | enum | M | FREE = 0: the nodes follow the user pointing |
| | | | device (that can be a HMD, a mouse, a laser |
| | | | pointing device, etc.) and its rotation, |
| | | | FREE_FIXED_ROTATION=1: the nodes |
| | | | follow the user pointing device but without |
| | | | rotation, |
| | | | SLIDE=2: the nodes move linearly along the |
| | | | provided axis by following the user pointing |
| | | | device, |
| | | | TRANSLATE=3: the nodes translate by |
| | | | following the user pointing device, |
| | | | ROTATE=4: the nodes rotate around the |
| | | | provided axis by following the user pointing |
| | | | device, |
| | | | SCALE=5: performs a central scaling of the |
| | | | nodes by following the user pointing device. |
| axis | array | O | (x,y,z) coordinates of the axis used for |
| | | | rotation and sliding. These coordinates are |
| | | | relative to the local space created by the |
| | | | USER_INPUT trigger activation. E.g. a |
| | | | “/user/hand/left/pose” user input trigger |
| | | | creates a local space attached to the user left |
| | | | hand.. |
| nodes | array | M | Indices of the nodes in the nodes tree to be |
| | | | manipulated. |
| } | | | |
| If (type = | | | |
| SET_MATERIAL) { | | | |
| material | number | M | Index of the material in a material array to |
| | | | apply to the nodes. |
| nodes | array | M | Indices of the nodes in the node tree to set |
| | | | their material. |
| } | | | |

For every field in the table, a default value may be determined.

FIG. 2B shows a syntax compliant with the present principles to represent the actions of the illustrative example described above. The field “actions” comprises a description of the three actions needed to execute the two behaviors of the illustrative example, as well as one disabling action. The first action to enable the object at node 0 in the node tree has the index 0 as it is the first action in the action array. The action to place the object at node 0 on the user's left hand has the index 1 and the action to transform the object at node 0 according, in the example, a transform matrix has the index 2. A fourth action to disable the object at node 0, with the index 3, is the interrupt action common to the two behaviors.

Items of the array of field ‘behaviors’ (illustrated in FIG. 2C) are defined according to the following table:

| Name | Type | Usage | Description |
|---|---|---|---|
| triggers | array | M | Indices in the triggers array of the triggers |
| | | | considered for this behavior. |
| actions | array | M | Indices in the actions array of the actions |
| | | | considered for this behavior. |
| triggersControl | enum | M | LOGICAL_OR = 0: an activation of any of the |
| | | | defined triggers shall execute the defined actions, |
| | | | LOGICAL_AND=1: all the defined triggers |
| | | | shall be activated to execute the defined actions. |
| actionsControl | enum | M | Defines the way to execute the defined actions. |
| | | | SEQUENTIAL=0: each defined action is |
| | | | executed sequentially in the order of the actions |
| | | | array, |
| | | | PARALLEL=1: the defined actions are executed |
| | | | concurrently. |
| interruptAction | number | O | Index in the actions array of the action to be |
| | | | executed if the behavior is still on-going and is |
| | | | no longer defined in a newly received scene |
| | | | update. |
| priority | number | M | Weight associated with the behavior. Used to |
| | | | select a behavior when several behaviors are |
| | | | active at same time for one node. |

For every field in the table, a default value may be determined.

FIG. 2C shows a syntax compliant with the present principles to represent the behaviors of the illustrative example described above. The field “behaviors” comprises a description of the two behaviors of the illustrative example. The lists of triggers and actions are indicated by the indices in the trigger array of FIG. 2A and the action array of FIG. 2B. The interrupt action of the two behaviors refers to action number 3 in the action array. The second behavior has a higher priority than the first behavior. As the two behaviors apply to the same node 0 of the node tree, the second behavior is selected if the two behaviors are active at the same time.

FIG. 2D shows an example syntax of complementary information according to the present principles. For example, the scene and the nodes may be named. Triggers, actions and behaviors may also have a unique id number or a unique name. So, when a scene description is updated, it is straightforward to detect whether an on-going behavior or a node belongs to the new scene description.

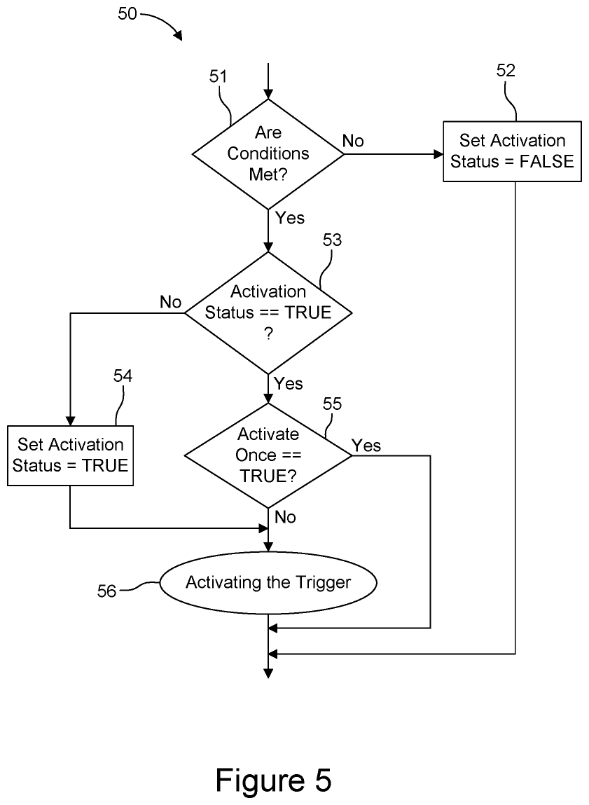

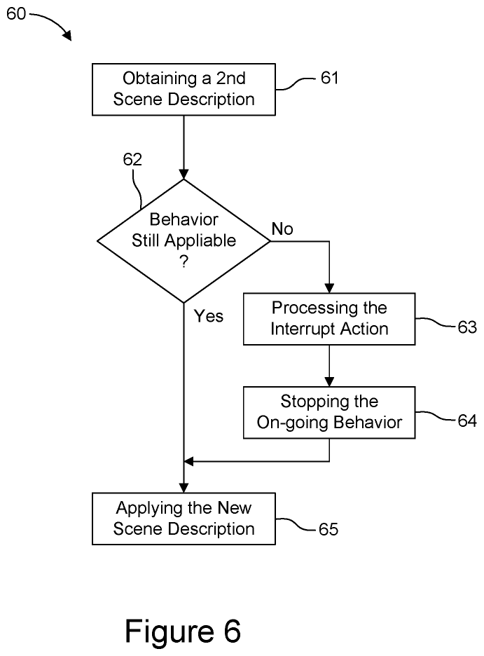

FIG. 3 shows an example architecture of an XR processing engine 30 which may be configured to implement a method described in relation with FIGS. 5 and 6. A device according to the architecture of FIG. 3 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 3), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method described in relation with FIGS. 5 and 6, and belongs to a set comprising:
a mobile device;
a communication device;
a game device;
a tablet (or tablet computer);
a laptop;
a still picture camera;
a video camera.

FIG. 4 shows an example of an embodiment of the syntax of a data stream encoding an extended reality scene description according to the present principles. FIG. 4 shows an example structure 4 of an XR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described in relation to FIGS. 2A to 2D.

FIG. 5 illustrates a method 50 for rendering an extended reality scene according to a first embodiment of the present principles. When a first scene description is received, triggers of the trigger array are considered. It is possible that one or more of them may be discarded because the rendering device is not equipped to detect their conditions. For example, a trigger may be based on a temperature while the rendering device has no heat sensor. So, the steps of method 50 apply to at least one trigger; to every trigger of the scene description if possible. At a step 51, the conditions described in the metadata describing the trigger are tested by the rendering device using the related sensors. If the conditions are not met, an activation status set to false is attributed to the trigger at running time at a step 52. If the conditions are met, the rendering device checks whether the activation status of the trigger is already set to true at a step 53. If not, the activation status of the trigger is set to true at a step 54 and a step 56 is performed. If so, the rendering device checks whether the field activate_once of the trigger in the scene description is set to true. If so, step 56 is overpassed. Otherwise, step 56 is performed. Step 56 activates the trigger. At step 56, every behavior using this trigger is notified that the trigger is activated or re-activated.

At running time, every behavior has an on-going status indicating whether the triggers of the behavior have been activated according to the activation mode and, so, whether the actions of the behavior are actually executed.

FIG. 6 illustrates a method 60 for rendering an extended reality scene according to a second embodiment of the present principles. For method 60, the extended reality application is already running. A first scene description with an interactivity extension according to the present principles has been received and is used to run the XR application. At least one behavior is on-going, that is its actions are executed. At step 61, a second scene description is obtained. If the second scene extension has no interactivity extension, it is considered has having an empty array of behaviors. The obtained data may be a partial description indicating the differences between the first scene description and the second scene description. The second description may comprise new behaviors that was not comprised in the first description or behaviors equivalent to the behaviors comprised in the first scene description. Method 60 applies to every on-going behavior of the first scene description. At step 62, the rendering device checks whether a given on-going behavior of the first scene description is appliable with the objects of the node tree of the second scene description. Indeed, actions of an on-going behavior of the first scene description apply to objects described in the node tree of the first scene description. If the node tree of the second description does not comprise these objects or if these objects have been modified in the second scene description and that the actions of the on-going behavior do not apply to these modified objects, the on-going behavior is no longer appliable. Then, the on-going behavior is interrupted and stopped at steps 63 and 64. If the on-going behavior is still appliable in the context of the second scene description, then the on-going behavior continues, and step 65 is performed. In a variant, if the second scene description does not comprise a behavior equivalent to an on-going behavior, the on-going behavior is considered as no longer appliable.

At step 63, the interrupt action (if there is one in the description) is performed. At step at step 64 the on-going behavior is stopped. Then step 65 is performed. At step 65, the second scene description replaces the first description in the running XR application. Method 60 is iterated if a new scene description is received.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for rendering an extended reality scene relative to a user in a timed environment, the method comprising:
obtaining a description of the extended reality scene, the description comprising:
a scene tree describing at least one timed objects, virtual objects or relationships between objects;
behavior data items, wherein a behavior data item comprises:
at least a trigger, wherein a trigger is a description of conditions;
a trigger being activated when its conditions are detected in the timed environment; and
at least an action, wherein an action is a description of a process to be performed by an extended reality engine on objects described by nodes of the scene tree; and
on condition that the at least a trigger of a behavior data item is activated, apply actions of the behavior data item.

2. The method of claim 1, comprising:
when a description of the extended reality scene is obtained, attributing an activation status set to false to at least one trigger of the description; and
when the conditions of the at least one trigger are met for a first time, setting the activation status of the trigger to true; and activating the trigger.

3. The method of claim 2, wherein, when the conditions of the at least one trigger are met, if the activation status of the trigger is set to true, activating the trigger only if the description of the trigger authorizes a second activation.

4. The method of one of claim 1, wherein behavior data items comprise a priority parameter and, when the at least a trigger of at least two behavior data items is activated, applying the at least an action of one of the at least two behaviors data items according to the priority parameter of the at least two behavior data items.

5. A method for updating, at runtime, wherein a first description of an extended reality scene comprises behavior data items with a second description of the extended reality scene, and wherein the method comprises, for each on-going behavior data item of the first description, if the on-going behavior data item is not appliable with the second description:
processing an interrupt action if existing for the on-going behavior data item in the first description;
stopping the on-going behavior data item; and
applying the second description.

6. A device for rendering an extended reality scene relative to a user in a timed environment, the device comprising a memory associated with a processor configured for:
obtaining a description of the extended reality scene, the description comprising:
a scene tree describing at least one timed objects, virtual objects or relationships between objects;
behavior data items, wherein a behavior data item comprises:
at least a trigger, wherein a trigger being is a description of conditions;
a trigger being activated when its conditions are detected in the timed environment; and
at least an action, wherein an action being is a description of a process to be performed by an extended reality engine on objects described by nodes of the scene tree; and
on condition that the at least a trigger of a behavior data item is activated, apply actions of the behavior data item.

7. The device of claim 6, wherein the processor is further configured for:
when a description of the extended reality scene is obtained, attributing an activation status set to false to at least one trigger of the description; and
when the conditions of the at least one trigger are met for a first time, setting the activation status of the trigger to true; and activating the trigger.

8. The device of claim 7, wherein the processor is further configured for, when the conditions of the at least one trigger are met, if the activation status of the trigger is set to true, activating the trigger only if the description of the trigger authorizes a second activation.

9. The device of one of claim 6, wherein behavior data items comprise a priority parameter and, when the at least a trigger of at least two behavior data items is activated, the processor is configured for applying the at least an action of one of the at least two behavior data items according to the priority parameter of the at least two behavior data items.

10. A device for updating, at runtime, wherein a first description of an extended reality scene comprises behavior data items with a second description of the extended reality scene, the device comprising a memory associated with a processor configured for:
for each on-going behavior data item of the first description, if the on-going behavior data item is not appliable with the second description:
processing an interrupt action if existing for an on-going behavior data item in the first description;
stopping the on-going behavior data item; and
applying the second description.

11. The method of claim 2, wherein behavior data items comprise a priority parameter and, when the at least a trigger of at least two behavior data items is activated, applying the at least an action of one of the at least two behaviors data items according to the priority parameter of the at least two behavior data items.

12. The method of claim 3, wherein behavior data items comprise a priority parameter and, when the at least a trigger of at least two behavior data items is activated, applying the at least an action of one of the at least two behaviors data items according to the priority parameter of the at least two behavior data items.

13. The device of claim 7, wherein behavior data items comprise a priority parameter and, when the at least a trigger of at least two behavior data items is activated, the processor is configured for applying the at least an action of one of the at least two behavior data items according to the priority parameter of the at least two behavior data items.

14. The device of claim 8, wherein behavior data items comprise a priority parameter and, when the at least a trigger of at least two behavior data items is activated, the processor is configured for applying the at least an action of one of the at least two behavior data items according to the priority parameter of the at least two behavior data items.
